(19) United States
(12) Patent Application Publication
(10) Pub. No.: US 2007/0040403 A1
(43) Pub. Date: Feb. 22, 2007

(54) Roof-attached display device for vehicles

(75) Inventor: Cheng-Chi Yang, Sihu Township (TW)

Correspondence Address: BRUCE H. TROXELL;SUITE 1404, 5205 LEESBURG PIKE, FALLS CHURCH, VA, 22041, US

(73) Assignee: E-Lead Electronic Co., Ltd.

(21) Appl. No.: 11/186,767

(22) Filed: Jul. 22, 2005

(51) Int. Cl. B60R 7/00

(52) U.S. Cl. 296/37.7; 296/37.8

(57) ABSTRACT

A roof-attached display device for vehicles aiming to increase the elevation of a display panel includes at least a chassis, an axle mechanism, a display panel and an anchor mechanism. The upper edge of a screen on the display panel is at an elevation higher than the axle of the axle mechanism and located on a higher elevation. Hence the screen has a upper moving space to allow the display panel to be moved closer to the roof surface. When the display panel is flipped down for viewing, it does not block the visual area of the rearview mirror, and driving safety can be maintained.

### BACKGROUND OF THE INVENTION

1. Field of the Invention

The invention relates to a roof-attached display device for vehicles and particularly to a roof-attached display device for vehicles to raise the elevation of the display panel thereby to prevent blocking of the visual area of the rearview mirror when the display panel is flipped down to improve driving safety.

2. Description of the Prior Art

Installing a display device in vehicles is a new developing trend, especially the roof-attached display device seeable by passengers on the rear seat. For instance, R.O.C. patent No. TWM255813 discloses such an example.

However the conventional roof-attached display device has a big disadvantage (referring to FIGS. 1 and 8). It is installed on a roof surface 51 of a vehicle 5. It has a chassis 10 at a selected thickness H1, and an axle 102 on a upper edge of a display panel 101. The display panel 101 has a screen 103 with a upper edge below the axle 102. When the display panel 101 is flipped down, its lower edge is spaced from the roof surface 51 at a distance H2 which is greater than the distance H3 between the rearview mirror 52 and the roof surface 51. Hence the visual area of the rearview mirror 52 is blocked. This seriously affects driving safety.

### SUMMARY OF THE INVENTION

In view of the aforesaid problem occurred to the conventional technique, the present invention aims to provide a roof-attached display device for vehicles that includes at least a chassis, an axle mechanism, a display panel and an anchor mechanism. The upper edge of the screen on the display panel is at an elevation higher than the axle of the axle mechanism and located on a higher elevation. Hence the screen has a upper moving space, and the display panel can be located closer to the roof surface. When the display panel is flipped down for viewing, it does not block the visual area of the rearview mirror, and driving safety can be maintained.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a schematic view of a conventional roof-attached display device installed in a vehicle.

FIG. 2 is a perspective view of the invention.

FIG. 3 is an exploded view of the invention.

FIG. 4 is another perspective view of the invention.

FIG. 5 is a sectional view of the invention in an assembled condition.

FIG. 6 is a schematic view of the invention in a flipped down condition.

FIG. 7 is a schematic view of the invention installed in a vehicle.

FIG. 8 is a schematic view of a conventional roof-attached display device flipped down in a vehicle.

FIG. 9 is a schematic view of the invention in a flipped down condition.

FIG. 10 is a schematic view of another embodiment of the invention.

FIG. 11 is a schematic view of another embodiment of the invention in a flipped down condition.

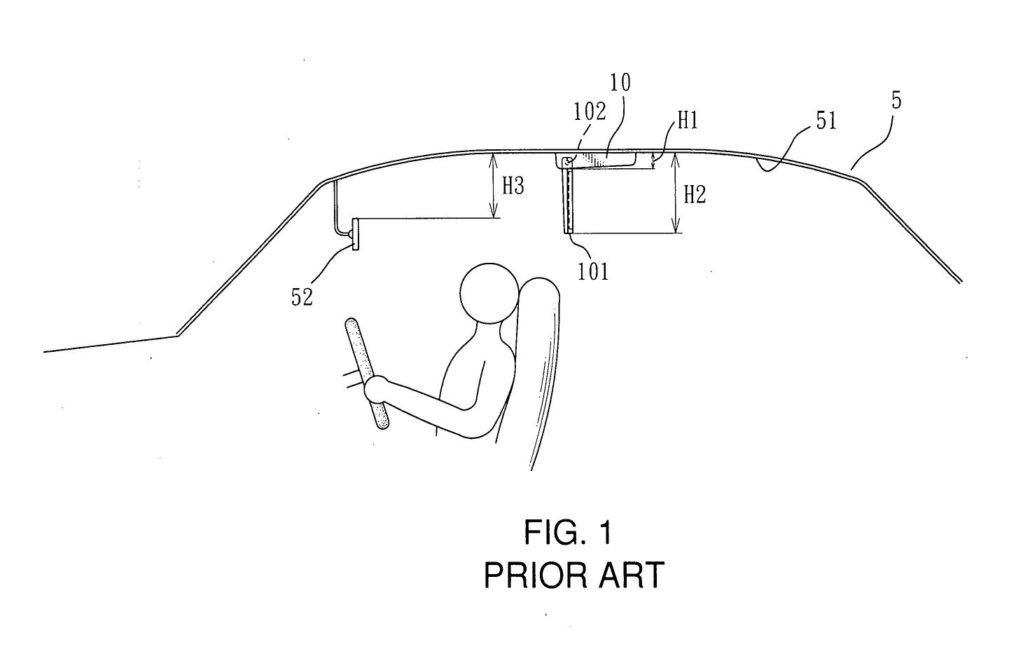

### DESCRIPTION OF THE PREFERRED EMBODIMENTS

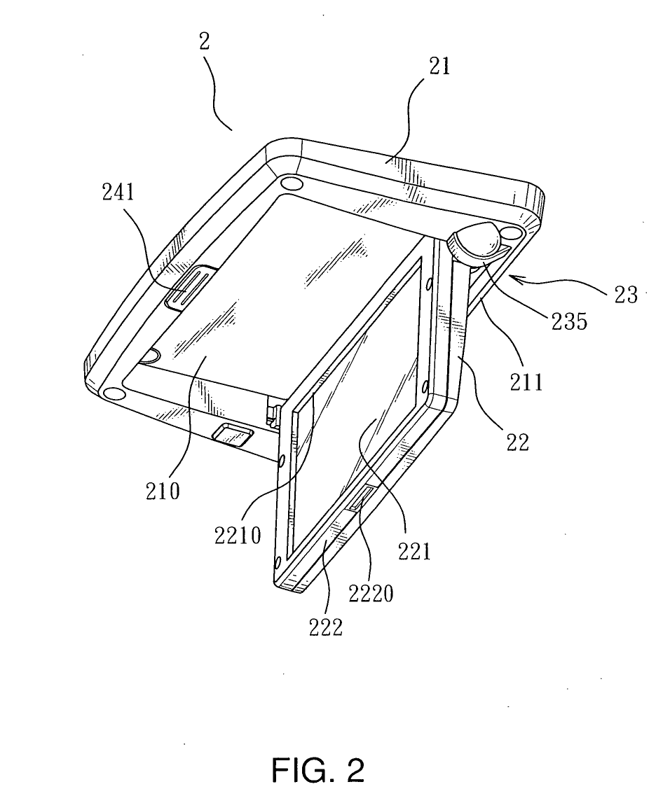

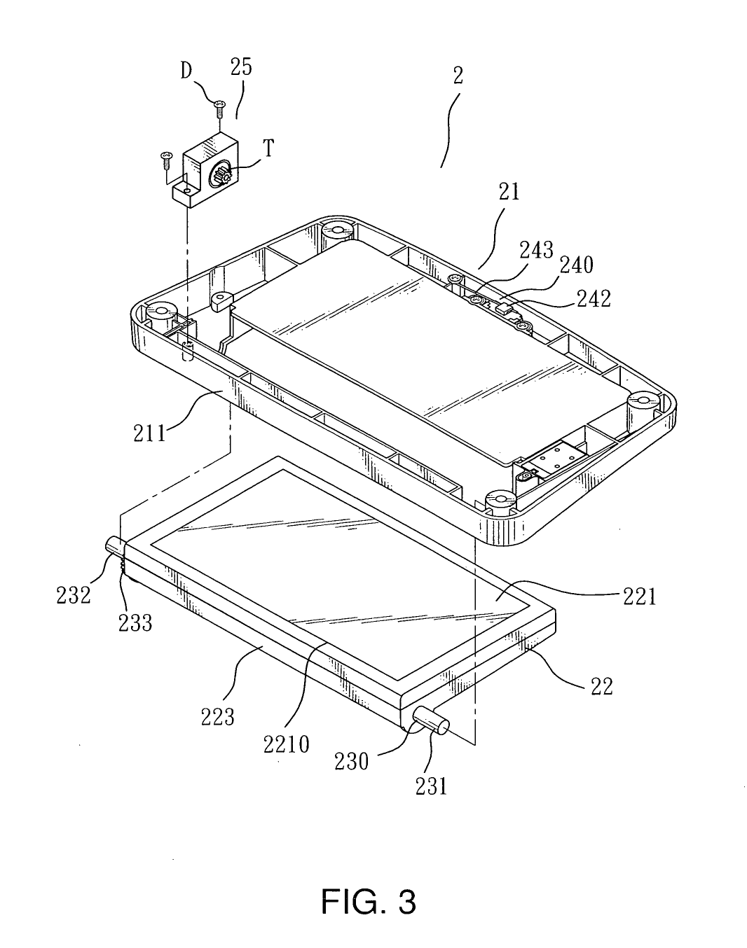

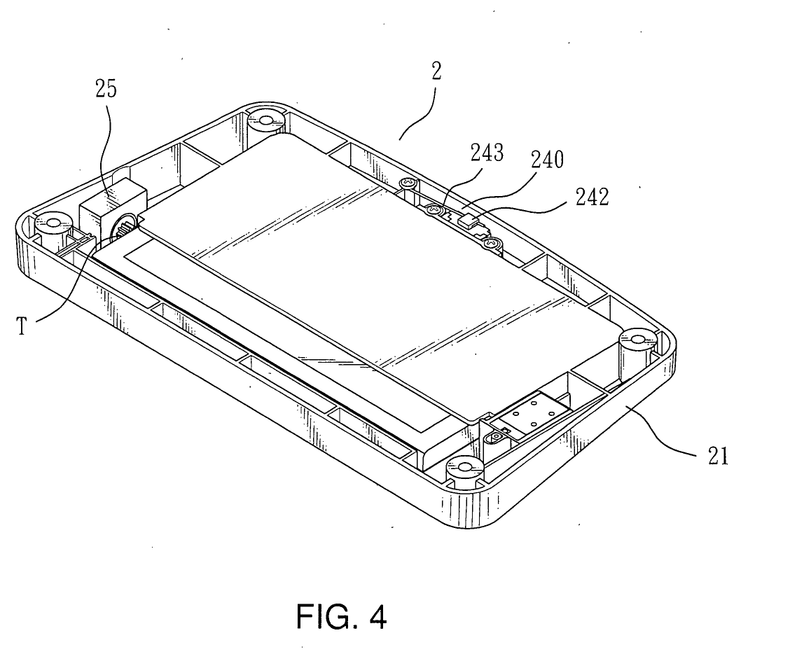

Referring to FIGS. 2 through 5, the roof-attached display device 2 for vehicles according to the invention includes at least a chassis 21, an axle mechanism 23, a display panel 22 and an anchor mechanism 24.

The chassis 21 has a housing space 210 to hold the display device 22 and one end 211 to hold the axle mechanism 23 to hinge the display panel 22.

The axle mechanism 23 includes an axle 230 and two axle seats 234 and 235 to pivotally couple with two stub shafts 231 and 232 on two ends of the axle 230. The display panel 22 is hinged on the axle seats and swivelable.

The display panel 22 has a screen 221 on a lateral side and two sides close to a top edge 223 to be hinged on the axle mechanism 23.

The anchor mechanism 24 includes a button assembly 240 located in the chassis 21 and a latch trough 2220 formed on a lower edge 222 of the display panel 22.

The screen 221 has a upper edge 2210 located at an elevation higher than the axle 230 and on a upper portion of a rear side thereof. The axis A2 of the axle 230 and the longitudinal center line A1 of the display panel 22 are not located on the same plane (referring to FIG. 9). Hence there is a upper moving space above the screen 221 to enable the display panel 22 to be moved closer to the roof surface 51.

The axle mechanism 23 further has a deceleration mechanism 25. It is fastened to one corner of the one end 211 of the chassis 21 through a screw D. The deceleration mechanism 25 includes at least one gear T to engage with an axle gear 233 on the stub shaft 232 to reduce the fast moving impact when the display panel 22 is flipped down.

The button assembly 240 of the anchor mechanism 24 includes a pushbutton 241, a latch tongue 242 and an elastic element 243.

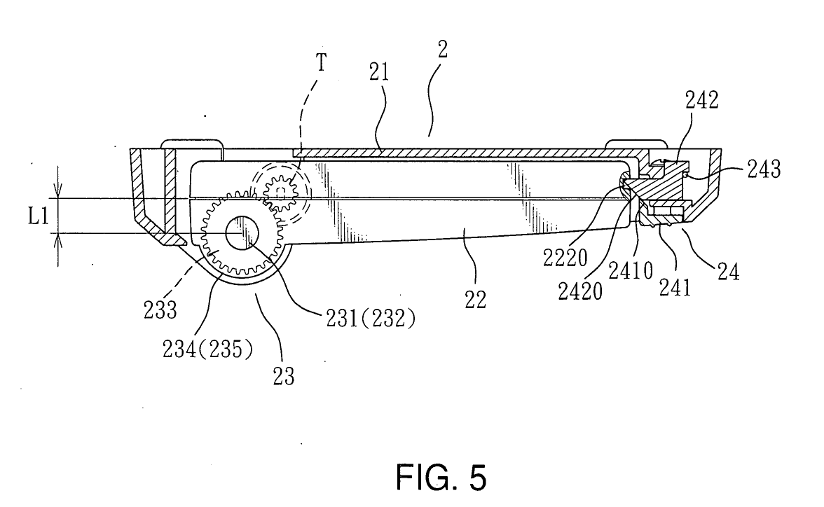

Referring to FIGS. 5, 6 and 7, when users want to see a multimedia optical disk, depress the pushbutton 241; an inclined rib 2410 on one side forces a latch end 2420 of the latch tongue 242 to retract from the latch trough 2220 and a disengaged condition is formed. The display panel 22 flips down due to its own weight. As the gear T of the deceleration mechanism 25 is engaged with the axle gear 233, a buffering effect is generated to reduce the flipping speed of the display panel 22. When the display panel 22 is not in use and to be folded, it can be done by directly moving the display panel 22. The latch tongue 242 is pushed outwards by the elastic element 243 in normal conditions. Hence the latch tongue can be latched in the latch trough 2220 to anchor the folding display panel 22.

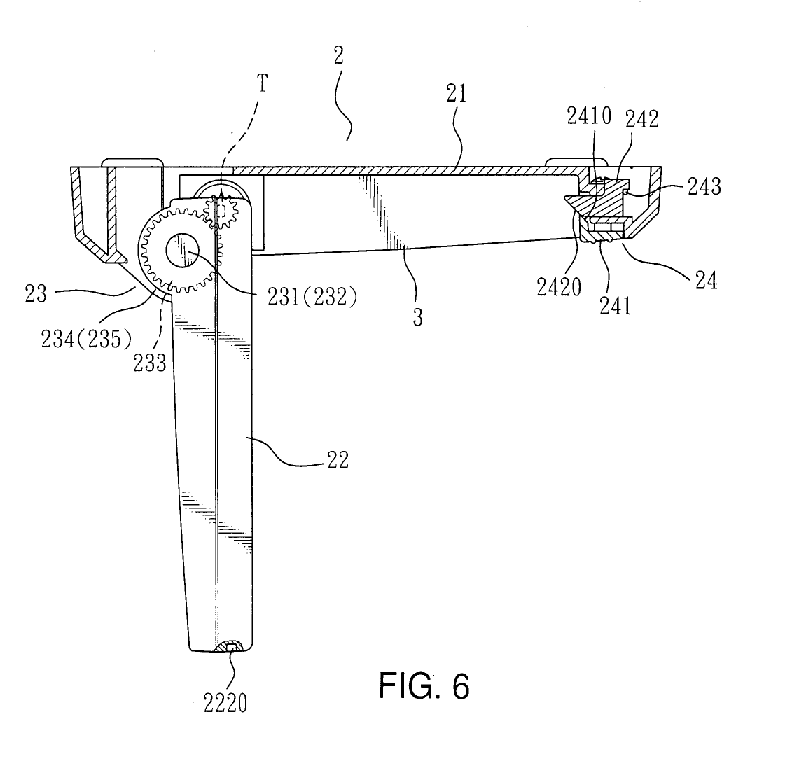

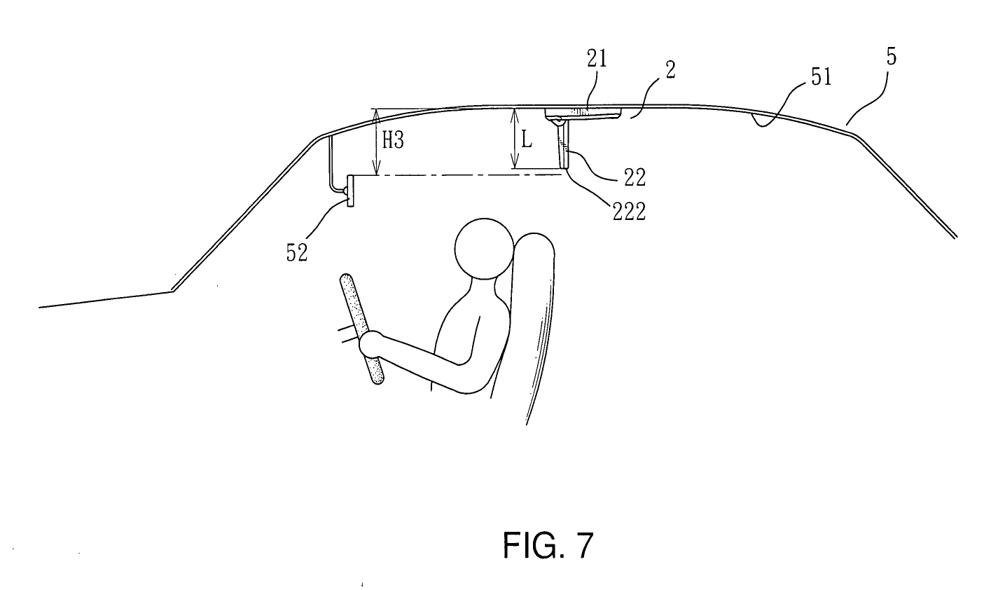

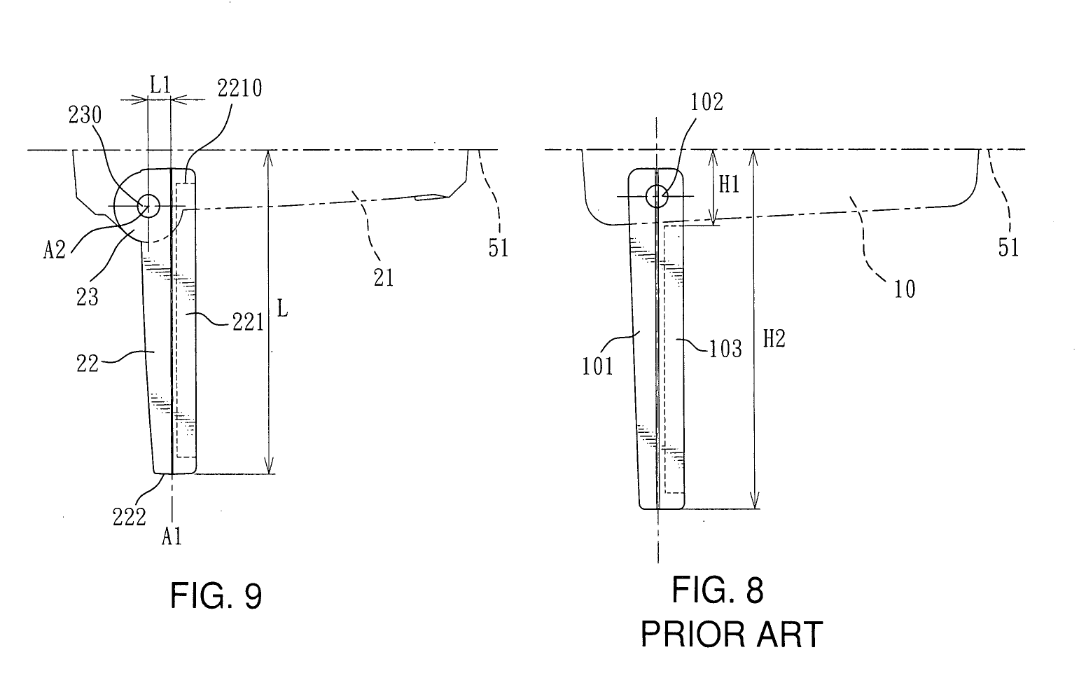

As the axis A2 of the axle 230 and the center line Al of the display panel 22 are not located on the same plane, and the upper edge 2210 of the screen 221 is at a higher elevation than the axle 230, and on a higher location of the rear side (namely there is a distance L1 between the axis A2 and the center line Al of the display panel 22, as shown in FIG. 9), when the display panel 22 is flipped down, the upper edge 2210 of the screen 22 is above the axle 230. Thus the display panel 22 is at a higher elevation (referring to FIG. 7). Therefore, when the display panel 22 is flipped down, the axle mechanism 23 can raise the elevation of the display panel 22. And the lower edge 222 of the display panel is spaced from the roof surface 51 at a distance L which is smaller than the distance H3 between the upper edge of the rearview mirror 52 and the roof surface 51. Hence the visual area of the rearview mirror is not blocked, and driving safety can be maintained.

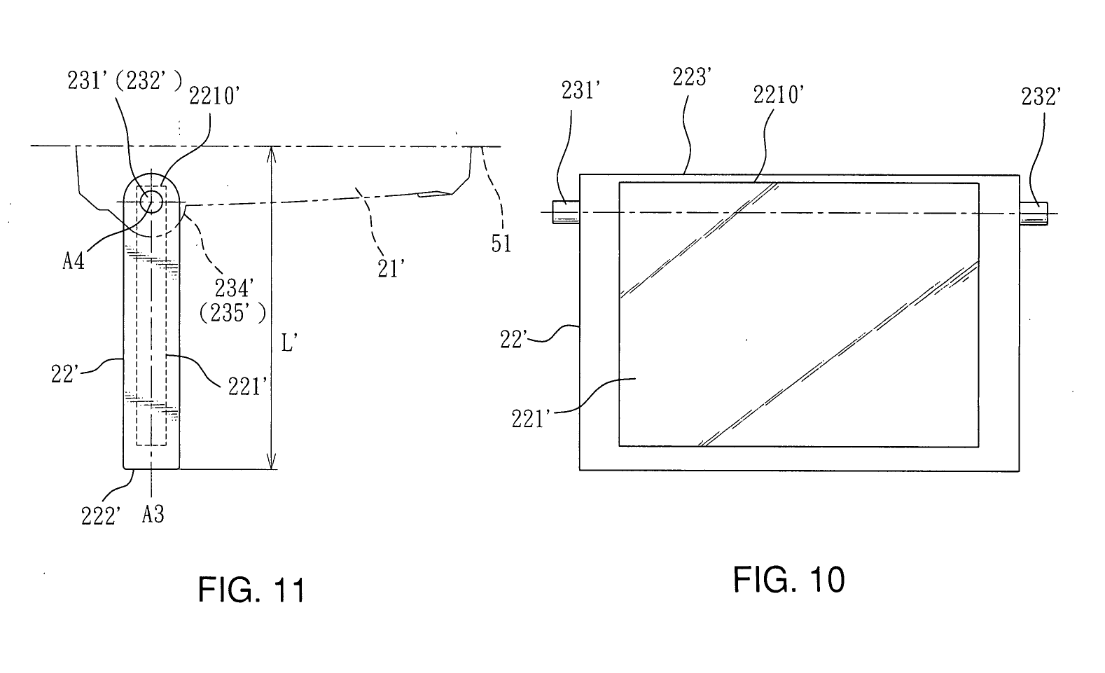

Refer to FIGS. 10 and 11 for another embodiment of the invention. It includes an axle mechanism 23′ which has two stub shafts 231′ and 232′ located on two sides of a display panel 22′ close to a top edge 223′ to be hinged on two axle seats 234′ and 235′. The axis A4 of the stub shafts 231′ and 232′ and the longitudinal center line A3 of the display panel 22′ are located on the same plane. The upper edge 2210′ of the screen 221′ on the display panel 22′ is located at an elevation higher than the stub shafts 231′ and 232′. Hence the screen 221′ can be raised to a higher elevation and closer to the roof surface 51. When the display panel 22′ is flipped down, the lower edge 222′ is spaced from the roof surface 51 at a distance L′ which is smaller than the distance H3 spaced from the roof surface 51, thus the visual area is not blocked, and driving safety can be maintained.

In summary, the invention can increase the elevation of the display panel after being flipped down so that the visual area of the rearview mirror is not blocked while the multimedia optical disk is playing, and driving safety of the vehicle can be maintained.

While the preferred embodiments of the invention have been set forth for the purpose of disclosure, modifications of the disclosed embodiments of the invention as well as other embodiment thereof may occur to those skilled in the art. Accordingly, the appended claims are intended to cover all embodiments which do not depart from the spirit and scope of the invention.

I claim:

1. A roof-attached display device comprising at least a chassis, an axle mechanism and a display panel; wherein:
the chassis has a housing space to hold the display panel and one end to hold the axle mechanism which is pivotally coupled with the display panel;
the axle mechanism includes an axle and two stub shafts which are hinged on two axle seats to pivotally couple with the display panel such that the display panel is swivelable about the axle seats;
the display panel has a screen on a lateral side and two sides close to a top edge to be hinged on the axle mechanism;
wherein the screen has a upper edge at an elevation higher than the axis of the axle mechanism and located on a upper portion of a rear side thereof such that the axis of the axle and the longitudinal center line of the display panel are not located on a same plane, and the screen has a upper moving space to allow the display panel to be moved closer to a roof surface of a vehicle.

2. The roof-attached display device of claim 1, wherein one of the stub shafts is coupled with an axle gear.

3. The roof-attached display device of claim 1, wherein the axle mechanism includes a deceleration mechanism which has at least one gear.

4. The roof-attached display device of claim 1 further having an anchor mechanism which includes a button assembly located on the chassis and a latch trough formed on a lower edge of the display panel.

5. The roof-attached display device of claim 4, wherein the button assembly includes a pushbutton, a latch tongue and an elastic element.

6. A roof-attached display device comprising at least a chassis, an axle mechanism and a display panel; wherein:
the chassis has a housing space to hold the display panel and one end to hold the axle mechanism which is pivotally coupled with the display panel;
the axle mechanism includes two stub shafts which are hinged on two axle seats to pivotally couple with the display panel such that the display panel is swivelable about the axle seats;
the display panel has a screen on a lateral side and two sides close to a top edge to be hinged on the axle mechanism;
wherein the screen has a upper edge at an elevation higher than the two stub shafts of the axle mechanism, the axis of the stub shafts and the longitudinal center line of the display panel being located on a same plane, and the screen having a upper moving space to allow the display panel to be moved closer to a roof surface of a vehicle.

7. The roof-attached display device of claim 6, wherein one of the stub shafts is coupled with an axle gear.

8. The roof-attached display device of claim 6, wherein the axle mechanism includes a deceleration mechanism which has at least one gear.

9. The roof-attached display device of claim 6 further having an anchor mechanism which includes a button assembly located on the chassis and a latch trough formed on a lower edge of the display panel.

10. The roof-attached display device of claim 9, wherein the button assembly includes a pushbutton, a latch tongue and an elastic element.
